(19) United States
(12) Patent Application Publication
(10) Pub. No.: US 2024/0084109 A1
(43) Pub. Date: Mar. 14, 2024

(54) THERMOPLASTIC PULVERULENT COMPOSITION FOR THREE-DIMENSIONAL PRINTING

(71) Applicant: BASF SE, Ludwigshafen am Rhein (DE)

(72) Inventors: Wei Zheng FAN, Shanghai (CN); Zhi Zhong CAI, Shanghai (CN); Yan Sheng LI, Shanghai (CN)

(21) Appl. No.: 18/269,966

(22) PCT Filed: Dec. 10, 2021
(86) PCT No.: PCT/EP2021/085229

§ 371 Date: Jun. 28, 2023

(30) Foreign Application Priority Data
Dec. 29, 2020 (WO) PCT/CN2020/140780

(51) Int. Cl. C08K 9/06; B33Y 70/10; C08K 3/36; C08K 5/5415; C09D 11/102; C09D 177/06

(52) U.S. Cl. CPC C08K 9/06; B33Y 70/10; C08K 3/36; C08K 5/5415; C09D 11/102; C09D 177/06; B33Y 10/00; C08K 2201/005; C08K 2201/006; C08K 2201/011

(57) ABSTRACT

The present disclosure relates to a thermoplastic pulverulent composition comprising (a) at least one silica particle treated with alkoxysilane; and (b) at least one thermoplastic polymer. The present disclosure also relates to a 3D-printed object formed from the thermoplastic pulverulent composition and a process of forming the 3D-printed object. The thermoplastic pulverulent composition shows good powder flowability and the printed object obtained from said thermoplastic pulverulent composition surprisingly shows high elongation at break, high impact strength, good toughness and low surface roughness.

### TECHNOLOGY FIELD

The present invention relates to a thermoplastic pulverulent composition for three-dimensional printing, further relates to a 3D-printed object formed from the thermoplastic pulverulent composition as well as a process of forming the 3D-printed object.

### BACKGROUND

3D-printing technologies using thermoplastic powders, e.g. selective laser sintering (SLS), multi jet fusion (MJF) and selective heat sintering (SHS), have been used for rapid prototyping and rapid manufacturing processes. To obtain 3D printed parts for these technologies, thermoplastic powders are sintered by heat. Elongation at break and toughness of 3D printed parts are always poorer which become main drawbacks for 3D printing process. Moreover, good powder flowability of thermoplastic powder is also necessary for the printing process, which lead to good powder spread layer by layer. Therefore, there is a strong need to have thermoplastic powder with good powder flowability to enable successful 3D printing process in SLS, MJF or SHS, meanwhile with good elongation at break and toughness.

### SUMMARY OF THE INVENTION

It is an object of the invention to provide a thermoplastic pulverulent composition comprising silica particle treated with alkoxysilane and thermoplastic polymer, wherein the thermoplastic pulverulent composition shows good powder flowability and the printed object obtained from said thermoplastic pulverulent composition shows high elongation at break, high impact strength, good toughness and low surface roughness.

Another object of the present invention is to provide a 3D-printed object formed from the thermoplastic pulverulent composition of the present invention.

A further object of the present invention is to provide a process of forming 3D-printed object by using the thermoplastic pulverulent composition of the present invention.

It has been surprisingly found that the above objects can be achieved by following embodiments:
1. A thermoplastic pulverulent composition comprising
(a) at least one silica particle treated with alkoxysilane; and
(b) at least one thermoplastic polymer. [symbol]
2. The thermoplastic pulverulent composition according to item 1, wherein the silica particle treated with alkoxysilane has a BET surface area of from 15 to 600 m²/g or 20 to 400 m²/g or 20 to 200 m²/g.
3. The thermoplastic pulverulent composition according to item 2, wherein the average primary particle size of the silica particle treated with alkoxysilane is in the range from 5 to 500 nm, preferably from 7 to 400 nm, or from 10 to 250 nm.
4. The thermoplastic pulverulent composition according to any of items 1 to 3, wherein the amount of silica particle treated with alkoxysilane is in the range from 0.01 to 10 wt. %, preferably from 0.01 to 5 wt. %, more preferably from 0.04 to 3 wt. %, in particular from 0.08 to 2 wt. %, based on the total weight of the thermoplastic pulverulent composition.
5. The thermoplastic pulverulent composition according to any of items 1 to 4, wherein the thermoplastic polymer is selected from the group consisted of polyolefins, hydrocarbon resins, aromatic homopolymers and copolymers derived from vinyl aromatic monomers, halogen-containing polymers, polymers derived from α,β-unsaturated acids and derivatives thereof, polymers derived from unsaturated alcohols and amines or the acyl derivatives or acetals thereof, homopolymers and copolymers of cyclic ethers, polyacetals, polyphenylene oxides and sulphides, polyamides and co-polyamides, polyureas, polyimides, polyamide imides, polyether imides, polyester imides, polyhydantoins, polybenzimidazoles, polyesters, polyketones, polysulphones, polyether sulphones, polyether ketones, polycarbonates, polyurethanes and blends or mixtures of the aforementioned polymers.
6. The thermoplastic pulverulent composition according to any of items 1 to 5, wherein the thermoplastic polymer is selected from the group consisted of polyamides and co-polyamides, polyolefins, polyester and polyurethanes, and blends or mixtures of the aforementioned polymers.
7. The thermoplastic pulverulent composition according to any of items 1 to 6, wherein the average particle size (D₅₀) of the thermoplastic polymer is in the range from 0.1 to 1000 μm or from 0.1 to 500 μm or from 0.1 to 300 μm or from 0.1 to 200 μm.
8. The thermoplastic pulverulent composition according to any of items 1 to 7, wherein the amount of the thermoplastic polymer is in the range from 30 to 99.99 wt. %, preferably from 50 to 99.96 wt. %, more preferably from 70 to 99.92 wt. %, based on the total weight of the thermoplastic pulverulent composition.
9. The thermoplastic pulverulent composition according to any of items 1 to 8, wherein the thermoplastic pulverulent composition comprises at least one auxiliary in an amount of from 0 to 69 wt. %, preferably from 0 to 49 wt. % or from 0 to 29 wt. %, based on the total weight of the thermoplastic pulverulent composition.
10. A 3D-printed object formed from the thermoplastic pulverulent composition according to any of items 1 to 9.
11. The 3D-printed object according to item 10, wherein the 3D-printed objects include sole, outerwear, cloth, footwear, toy, mat, tire, hose, gloves and seals.
12. A process of forming 3D-printed object, comprising using the thermoplastic pulverulent composition according to any of items 1 to 9.
13. The process according to item 12, wherein the process comprises:
a) adding the thermoplastic pulverulent composition according to any of items 1 to 9 to a molding mixture, and
b) producing the molding by selectively bonding the powder.
14. The process according to item 13, wherein the molding produced in step b) is produced by a process for the layer-by-layer build-up of three-dimensional objects by selectively bonding portions of a powder to on another.
15. The process according to item 13 or 14, wherein the selectively bonding comprises selective laser sintering, selective inhibition of the bonding of powders, 3D printing, or a microwave process.

The thermoplastic pulverulent composition of the present invention shows good powder flowability and the printed object obtained from said thermoplastic pulverulent composition surprisingly shows high elongation at break, high impact strength, good toughness and low surface roughness.

### DESCRIPTION OF THE DRAWING

FIG. 1 shows the picture of printed samples prepared from the thermoplastic pulverulent composition of example 1a.

FIG. 2 shows the picture of printed samples prepared from the thermoplastic pulverulent composition of example 1b.

FIG. 3 shows the picture of printed samples prepared from the thermoplastic pulverulent composition of example 2b.

### EMBODIMENT OF THE INVENTION

The undefined article “a”, “an”, “the” means one or more of the species designated by the term following said article.

In the context of the present disclosure, any specific values mentioned for a feature (comprising the specific values mentioned in a range as the end point) can be recombined to form a new range.

One aspect of the present invention is directed to a thermoplastic pulverulent composition comprising
(a) at least one silica particle treated with alkoxysilane; and
(b) at least one thermoplastic polymer.

According to the present invention, the thermoplastic pulverulent composition comprises at least one silica particle treated with alkoxysilane as component (a).

The silica particle, which can be treated to provide the silica particle treated with alkoxysilane in accordance with the invention, can be selected from silica, fumed silica, precipitated silica, colloidal silica and mixture thereof.

In a preferred embodiment, the silica particles are colloidal silica particles. Colloidal silica particles are generally non-aggregated, individually discrete particles, which generally are spherical or nearly spherical in shape, but can have other shapes (e.g., shapes with elliptical, square, or rectangular cross-sections). The structures of colloidal silica particles are different from fumed silica particles, which are chain-like structures of aggregated primary particles.

The silica particles, which can be treated to provide silica particles treated with alkoxysilane in accordance with the invention, are generally commercially available, or can be prepared by known methods from various starting materials (e.g., wet-process type silica). Typically, the colloidal silica starting material is available as a sol, which is a dispersion of colloidal silica in a suitable solvent, most often water alone or with a co-solvent and/or stabilizing agent.

According to the present invention, the silica particle is treated with alkoxysilane. The silica particle treated with alkoxysilane can be obtained by reacting the silica particle with alkoxysilane.

The alkoxysilane can be selected from monoalkoxysilane, dialkoxysilane, or trialkoxysilane. Usually, the alkoxysilane can have a structure of the following formula:

R¹ₙSi(OR²)₄₋ₙ

wherein R¹ can be selected from C₁-C₃₀ (preferably C₁-C₁₈, or C₁-C₁₂, or C₁-C₆ or C₁-C₄) alkyl, amino C₁-C₃₀ (preferably C₁-C₁₈, or C₁-C₁₂, or C₁-C₆ or C₁-C₄) alkyl, C₂-C₃₀ (preferably C₂-C₁₈, or C₂-C₁₂, or C₂-C₆ or C₂-C₄)alkenyl, and amino C₂-C₃₀ (preferably C₂-C₁₈, or C₂-C₁₂, or C₂-C₆ or C₂-C₄)alkenyl, C₃-C₁₀ cycloalkyl, and C₆-C₁₀ aryl; R² can be selected from C₁-C₁₈ alkyl (preferably C₁-C₁₅, C₁-C₁₀, C₁-C₈, C₁-C₆ or C₁-C₄ alkyl); and n is an integer from 1 to 3. Specific example of alkoxysilane can include, for example, trimethylmethoxysilane, dimethyldimethoxysilane, methyltrimethoxysilane, and the like.

In an embodiment, the alkoxysilane is a trialkoxysilane. The trialkoxysilane can have the structure of the following formula:

R¹Si(OR²)₃

wherein R¹ can be selected from C₁-C₃₀ (preferably C₁-C₁₈, or C₁-C₁₂, or C₁-C₆ or C₁-C₄) alkyl, amino C₁-C₃₀ (preferably C₁-C₁₈, or C₁-C₁₂, or C₁-C₆ or C₁-C₄) alkyl, C₂-C₃₀ (preferably C₂-C₁₈, or C₂-C₁₂, or C₂-C₆ or C₂-C₄) alkenyl, and amino C₂-C₃₀ (preferably C₂-C₁₈, or C₂-C₁₂, or C₂ -C₆ or C₂-C₄) alkenyl, and C₃-C₁₀ cycloalkyl; R² can be selected from C₁-C₁₀ alkyl (preferably C₁-C₈ or C₁-C₆ or C₁-C₄ alkyl).

The alkyl and alkenyl mentioned in the context of the present disclosure can be straight or branched.

Specific example of the trialkoxysilane can be selected from methyltrimethoxysilane, ethyltrimethoxysilane, propyltrimethoxysilane, butyltrimethoxysilane, pentyltrimethoxysilane, hexyltrimethoxysilane, heptyltrimethoxysilane, octyltrimethoxysilane, nonyltrimethoxysilane, decyltrimethoxysilane, undecyltrimethoxysilane, dodecyltrimethoxysilane, tetradecyltrimethoxysilane, stearyltrimethoxysilane, methyltriethoxysilane, ethyltriethoxysilane, propyltriethoxysilane, butyltriethoxysilane, pentyltriethoxysilane, hexyltriethoxysilane, heptyltriethoxysilane, nonyltriethoxysilane, decyltriethoxysilane, undecyltriethoxysilane, dodecyltriethoxysilane, tetradecyltriethoxysilane, stearyltriethoxysilane, and combinations thereof. In an embodiment, the trialkoxysilane can be selected from propyltrimethoxysilane, hexyltrimethoxysilane, heptyltrimethoxysilane, octyltrimethoxysilane, nonyltrimethoxysilane, decyltrimethoxysilane, undecyltrimethoxysilane, dodecyltrimethoxysilane, tetradecyltrimethoxysilane, stearyltrimethoxysilane, methyltriethoxysilane, ethyltriethoxysilane, propyltriethoxysilane, butyltriethoxysilane, pentyltriethoxysilane, hexyltriethoxysilane, heptyltriethoxysilane, octyltriethoxysilane, nonyltriethoxysilane, decyltriethoxysilane, undecyltriethoxysilane, dodecyltriethoxysilane, tetradecyltriethoxysilane, stearyltriethoxysilane, 3-aminopropyltriethoxysilane, 3-aminobutyltriethoxysilane, 3-aminobutyltriethoxysilane, and combinations thereof.

According to the present invention, the silica particle treated with alkoxysilane can have a BET surface area of from 15 to 600 m²/g, for example 15 m²/g, 20 m²/g, 25 m²/g, 30 m²/g, 35 m²/g, 40 m²/g, 45 m²/g, 50 m²/g, 60 m²/g, 80 m²/g, 100 m²/g, 150 m²/g, 200 m²/g, 250 m²/g, 300 m²/g, 400 m²/g, 450 m²/g, 500 m²/g or 550 m²/g, preferably from 20 to 400 m²/g, or from 20 to 200 m²/g, or from 20 to 100 m²/g.

The silica particle treated with alkoxysilane can have an average particle size (D₅₀) of from 0.1 to 250 μm, for example 0.2 μm, 0.3 μm, 0.4 μm, 0.5 μm, 0.8 μm, 1 μm, 1.5 μm, 2 μm, 5 μm, 10 μm, 15 μm, 20 μm, 30 μm, 50 μm, 80 μm, 100 μm, 150 μm, 200 μm or 250 μm, preferably from 0.1 to 200 μm or from 1 to 150 μm.

The silica particle treated with alkoxysilane are usually composed of nano-scale primary particles. The average primary particle size of the silica particle treated with alkoxysilane is generally in the range from 5 to 500 nm, for example 7 nm, 10 nm, 15 nm, 20 nm, 50 nm, 100 nm, 150 nm, 200 nm, 250 nm, 300 nm, 400 nm, or 500 nm, preferably from 7 to 400 nm, or from 10 to 250 nm. The primary particles can form larger agglomerates. Agglomerated particles (agglomerates) are composed of several primary particles loosely attached to each other, usually by van der Waals forces. As a result, de-agglomeration can be easily achieved for agglomerates. For example, dispersion of silica particle treated with alkoxysilane with polymer particles (dry dispersion) can be used to reverse agglomeration.

In the thermoplastic pulverulent composition of the present invention, the amount of silica particle treated with alkoxysilane can be in the range from 0.01 to 10 wt. %, for example 0.02 wt. %, 0.03 wt. %, 0.04 wt. %, 0.05 wt. %, 0.06 wt. %, 0.08 wt. %, 0.1 wt. %, 0.15 wt. %, 0.2 wt. %, 0.25 wt. %, 0.3 wt. %, 0.4 wt. %, 0.5 wt. %, 0.6 wt. %, 0.7 wt. %, 0.8 wt. %, 0.9 wt. %, 1 wt. %, 1.5 wt. %, 2 wt. %, 2.5 wt. %, 3 wt. %, 3.5 wt. %, 4 wt. %, 4.5 wt. %, 5 wt. %, 6 wt. %, 7 wt. %, 8 wt. %, or 9 wt. %, preferably from 0.01 to 8 wt. %, from 0.01 to 5 wt. %, from 0.04 to 8 wt. %, from 0.04 to 5 wt. %, from 0.04 to 4 wt. %, from 0.04 to 3 wt. %, from 0.04 to 2 wt. %, or from 0.04 to 1 wt. %, more preferably from 0.08 to 4 wt. %, from 0.08 to 3 wt. %, from 0.08 to 2 wt. %, or from 0.08 to 1 wt. %, or from 0.1 to 4 wt. %, from 0.1 to 3 wt. %, from 0.1 to 2 wt. %, from 0.1 to 1 wt. %, or from 0.15 to 4 wt. %, from 0.15 to 3 wt. %, from 0.15 to 2 wt. %, or from 0.15 to 1 wt. %, based on the total weight of the thermoplastic pulverulent composition.

According to the present invention, the thermoplastic pulverulent composition comprises at least one thermoplastic polymer as component (b).

A list of suitable thermoplastic polymers is given below:
1. Polyolefins, such as polymers of monoolefins and diolefins, for example thermoplastic polyolefins (TPO), such as polypropylene, polyisobutylene, polybut-1-ene, poly-4-methylpent-1-ene, polyvinylcyclohexane, polyisoprene or polybutadiene, as well as polymers of cycloolefins, for instance of cyclopentene or norbornene, polyethylene (which optionally can be cross linked), for example high density polymethylene (HDPE), high density and high molecular weight polyethylene (HDPE-HMW), high density and ultrahigh molecular weight polyethylene (HDPE-UHMW), medium density polyethylene (MDPE), low density polyethylene (LDPE), linear low density polyethylene (LLDPE), (VLDPE) and (ULDPE).
   Polyolefins, i.e. the polymers of monoolefins exemplified in the preceding paragraph, preferably polyethylene and polypropylene, can be prepared by different and especially by the following methods:
   a) Radical polymerisation (normally under high pressure and at elevated temperature).
   b) Catalytic polymerisation using a catalyst that normally contains one or more than one metal of groups IVb, Vb, VIb or VIII of the Periodic Table. These metals usually have one or more than one ligand, typically oxides, halides, alcoholates, esters, ethers, amines, alkyls, alkenyls and/or aryls that may be either α- or π-bond coordinated. These metal complexes may be in the free form or fixed on substrates, typically on activated magnesium chloride, titanium(III) chloride, and alumina or silicon oxide. These catalysts may be soluble or insoluble in the polymerisation medium. The catalysts can be used by themselves in the polymerisation or further activators may be used, typically metal alkyls, metal hydrides, metal alkyl halides, metal alkyl oxides or metal alkyloxanes, said metals being elements of groups Ia, IIa and/or IIIa of the Periodic Table. The activators may be modified conveniently with further ester, ether, and amine or silyl ether groups. These catalyst systems are usually termed Phillips, Standard Oil Indiana, Ziegler-Natta), TNZ (DuPont), metallocene or single site catalysts (SSC).
   Mixtures of polyolefins, for example mixtures of polypropylene with polyisobutylene, polypropylene with polyethylene (for example PP/HDPE, PP/LDPE) and mixtures of different types of polyethylene (for example LDPE/HDPE).
   Copolymers of monoolefins and diolefins with each other or with other vinyl monomers, for example ethylene/propylene copolymers, linear low density polyethylene (LLDPE) and mixtures thereof with low density polyethylene (LDPE), propylene/but-1-ene copolymers, propylene/isobutylene copolymers, ethylene/but-1-ene copolymers, ethylene/hexene copolymers, ethylene/methylpentene copolymers, ethylene/heptene copolymers, ethylene/octene copolymers, ethylene/vinylcyclohexane copolymers, ethylene/cycloolefin copolymers (e.g. ethylene/norbornene like COC), ethylene/1-olefins copolymers, where the 1-olefin is generated in-situ; propylene/butadiene copolymers, isobutylene/isoprene copolymers, ethylene/vinylcyclohexene copolymers, ethylene/alkyl acrylate copolymers, such as ethylene-n-butyl acrylate or methacrylate, ethylene/alkyl methacrylate copolymers, ethylene/vinyl acetate copolymers or ethylene/acrylic acid copolymers and their salts (ionomers) as well as terpolymers of ethylene with propylene and a diene such as hexadiene, dicyclopentadiene or ethylidene-norbornene; and mixtures of such copolymers with one another and with polymers mentioned in 1) above, for example polypropylene/ethylene-propylene copolymers, LDPE/ethylene-vinyl acetate copolymers (EVA), LDPE/ethylene-acrylic acid copolymers (EAA), LLDPE/EVA, LLDPE/EAA and alternating or random polyalkylene/carbon monoxide copolymers and mixtures thereof with other polymers, for example polyamides.
2. Hydrocarbon resins (for example C₅-C₉) including hydrogenated modifications thereof (e.g. tackifiers) and mixtures of polyalkylenes and starch;
   The homopolymers and copolymers mentioned above may have a stereo structure including syndiotactic, isotactic, hemi-isotactic or atactic; where atactic polymers are preferred. Stereo block polymers are also included.
3. Aromatic homopolymers and copolymers (comprising graft copolymers) derived from vinyl aromatic monomers including styrene, p-methylstyrene, α-methylstyrene, all isomers of vinyl toluene, especially p-vinyl toluene, all isomers of ethyl styrene, propyl styrene, vinyl biphenyl, vinyl naphthalene, and vinyl anthracene, and mixtures thereof. Homopolymers and copolymers may have a stereo structure including syndiotactic, isotactic, hemi-isotactic or atactic; where atactic polymers are preferred. Stereo block polymers are also included;
   a) Copolymers including aforementioned vinyl aromatic monomers and comonomers selected from ethylene, propylene, dienes, nitriles, acids, maleic anhydrides, maleimides, vinyl acetate and vinyl chloride or acrylic derivatives and mixtures thereof, for example styrene/butadiene, styrene/acrylonitrile, styrene/ethylene (interpolymers), styrene/alkyl methacrylate, styrene/butadiene/alkyl acrylate, styrene/butadiene/alkyl methacrylate, styrene/-maleic anhydride, styrene/acrylonitrile/methyl acrylate; mixtures of high impact strength of styrene copolymers and another polymer, for example a polyacrylate, a diene polymer or an ethylene/propylene/diene terpolymer; and block copolymers of styrene such as styrene/butadiene/styrene, styrene/isoprene/styrene, styrene/ethylene/butylene/styrene or styrene/ethylene/propylene/styrene.
   b) Hydrogenated aromatic polymers derived from hydrogenation of polymers mentioned under 3.), especially including polycyclohexylethylene (PCHE) prepared by hydrogenating atactic polystyrene, often referred to as polyvinylcyclohexane (PVCH).
   c) Hydrogenated aromatic polymers derived from hydrogenation of polymers mentioned under 3a). Homopolymers and copolymers may have a stereo structure including syndiotactic, isotactic, hemi-isotactic or atactic; where atactic polymers are preferred. Stereo block polymers are also included.
   Graft copolymers of vinyl aromatic monomers, such as styrene or α-methylstyrene, for example styrene on polybutadiene, styrene on polybutadiene-styrene or polybutadiene-acrylonitrile copolymers; styrene and acrylonitrile (or methacrylonitrile) on polybutadiene; styrene, acrylonitrile and methyl methacrylate on polybutadiene; styrene and maleic anhydride on polybutadiene; styrene, acrylonitrile and maleic anhydride or maleimide on polybutadiene; styrene and maleimide on polybutadiene; styrene and alkyl acrylates or methacrylates on polybutadiene; styrene and acrylonitrile on ethylene/propylene/diene terpolymers; styrene and acrylonitrile on polyalkyl acrylates or polyalkyl methacrylates, styrene and acrylonitrile on acrylate/butadiene copolymers, as well as mixtures thereof with the copolymers listed under 3), for example the copolymer mixtures known as ABS, MBS, ASA or AES polymers.
4. Halogen-containing polymers such as polychloroprene, chlorinated rubbers, chlorinated and brominated copolymer of isobutylene-isoprene (halobutyl rubber), chlorinated or sulpho-chlorinated polyethylene, copolymers of ethylene and chlorinated ethylene, epichlorohydrin homo- and copolymers, especially polymers of halogen-containing vinyl compounds, for example polyvinyl chloride, polyvinylidene chloride, polyvinyl fluoride, polyvinylidene fluoride, as well as copolymers thereof such as vinyl chloride/vinylidene chloride, vinyl chloride/vinyl acetate or vinylidene chloride/vinyl acetate copolymers.
5. Polymers derived from α,β-unsaturated acids and derivatives thereof such as polyacrylates and polymethacrylates; polymethyl methacrylates, polyacrylamides and polyacrylonitriles, impact-modified with butyl acrylate.
   Copolymers of the monomers mentioned under 5) with each other or with other unsaturated monomers, for example acrylonitrile/ butadiene copolymers, acrylonitrile/alkyl acrylate copolymers, acrylonitrile/alkoxyalkyl acrylate or acrylonitrile/vinyl halide copolymers or acrylonitrile/alkyl methacrylate/butadiene terpolymers.
6. Polymers derived from unsaturated alcohols and amines or the acyl derivatives or acetals thereof, for example polyvinyl alcohol, polyvinyl acetate, polyvinyl stearate, polyvinyl benzoate, polyvinyl maleate, polyvinyl butyral, polyallyl phthalate or polyallyl melamine; as well as their copolymers with olefins mentioned in 1 above.
7. Homopolymers and copolymers of cyclic ethers such as polyalkylene glycols, polyethylene oxide, polypropylene oxide or copolymers thereof with bisglycidyl ethers.
8. Polyacetals such as polyoxymethylene and those polyoxymethylenes, which contain ethylene oxide as a co-monomer; polyacetals modified with thermoplastic polyurethanes, acrylates or MBS.
9. Polyphenylene oxides and sulphides, and mixtures of polyphenylene oxides with styrene polymers or polyamides.
10. Polyamides and co-polyamides, such as those derived from diamines and dicarboxylic acids and/or from aminocarboxylic acids or the corresponding lactams, for example polyamide 4, polyamide 6 (PA6), polyamide 6/6, 6/10, 6/9, 6/12, 4/6, 12/12, polyamide 11 (PA11), polyamide 12 (PA12), aromatic polyamides starting from m-xylene diamine and adipic acid; polyamides prepared from hexamethylenediamine and isophthalic or/and terephthalic acid and with or without an elastomer as modifier, for example poly-2,4,4,-trimethylhexamethylene terephthalamide or poly-m-phenylene isophthalamide; and also block copolymers of the aforementioned polyamides with polyolefins, olefin copolymers, ionomers or chemically bonded or grafted elastomers; or with polyethers, e.g. with polyethylene glycol, polypropylene glycol or polytetramethylene glycol; as well as polyamides or co-polyamides modified with EPDM or ABS; and polyamides condensed during processing (RIM polyamide systems).
11. Polyureas, polyimides, polyamide imides, polyether imides, polyester imides, polyhydantoins and polybenzimidazoles.
12. Polyesters, such as those derived from dicarboxylic acids and diols and/or from hydroxycarboxylic acids or the corresponding lactones, for example polyethylene terephthalate, polybutylene terephthalate, poly-1,4-dimethylolcyclohexane terephthalate, polyalkylene naphthalate (PAN) and polyhydroxybenzoates, as well as block co-polyether esters derived from hydroxyl-terminated polyethers; and also polyesters modified with polycarbonates or MBS.
13. Polyketones.
14. Polysulphones, polyether sulphones and polyether ketones.
15. Polycarbonates that correspond to the general formula:

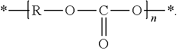

Such polycarbonates are obtainable by interfacial processes or by melt processes (catalytic transesterification). The polycarbonate may be either branched or linear in structure and may include any functional substituents. Polycarbonate copolymers and polycarbonate blends are also within the scope of the invention. The term polycarbonate should be interpreted as inclusive of copolymers and blends with other thermoplastics. Methods for the manufacture of polycarbonates are known, for example, from U.S. Pat. Nos. 3,030,331; 3,169,121; 4,130,458; 4,263,201; 4,286,083; 4,552,704; 5,210,268; and 5,606,007. A combination of two or more polycarbonates of different molecular weights may be used.
Preferred are polycarbonates obtainable by reaction of a diphenol, such as bisphenol A, with a carbonate source. Examples of suitable diphenols are:

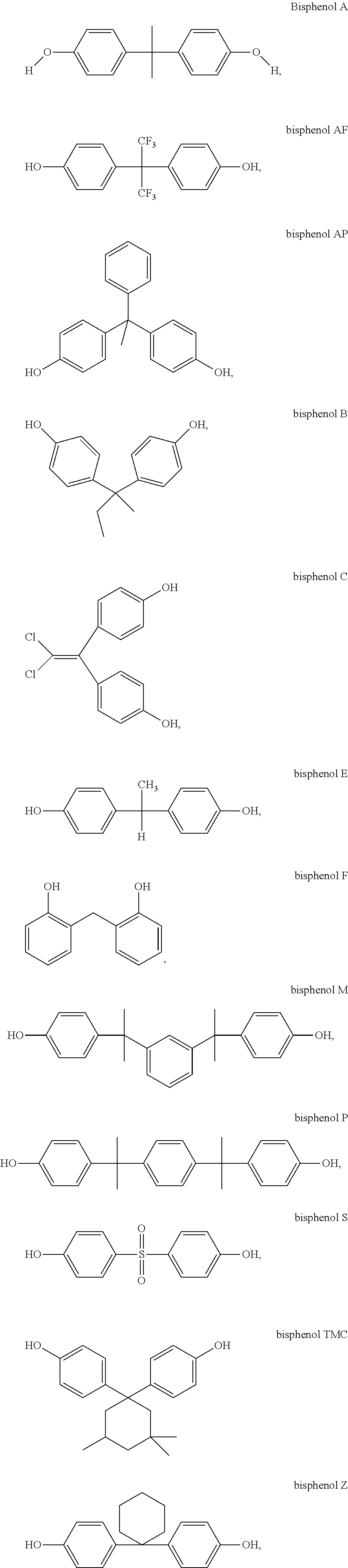

4,4′-(2-norbornylidene)bis(2,6-dichlorophenol); or fluorene-9-bisphenol:

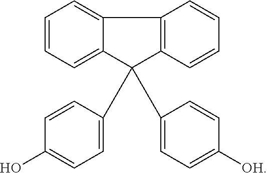 [SMILES: Oc1ccc(C2(c3ccc(O)cc3)c3ccccc3-c3ccccc32)cc1]

The carbonate source may be a carbonyl halide, a carbonate ester or a haloformate. Suitable carbonate halides are phosgene or carbonylbromide. Suitable carbonate esters are dialkylcarbonates, such as dimethyl- or diethylcarbonate, diphenyl carbonate, phenyl-alkylphenylcarbonate, such as phenyl-tolylcarbonate, dialkylcarbonates, such as dimethyl- or di-ethylcarbonate, di-(halophenyl)carbonates, such as di-(chlorophenyl)carbonate, di-(bromophenyl)carbonate, di-(trichlorophenyl)carbonate or di-(trichlorophenyl)carbonate, di-(alkylphenyl)carbonates, such as di-tolylcarbonate, naphthylcarbonate, dichloronaphthylcarbonate and others.
16. Polyurethanes, such as those derived from hydroxyl-terminated polyethers, polyesters or polybutadienes on the one hand and aliphatic or aromatic polyisocyanates on the other, as well as precursors thereof.
17. Blends of the aforementioned polymers (polyblends), for example PP/EPDM, Polyamide/EPDM or ABS, PVC/EVA, PVC/ABS, PVC/MBS, PC/ABS, PBTP/ABS, PC/ASA, PC/PBT, PVC/CPE, PVC/acrylates, POM/thermoplastic PUR, PC/thermoplastic PUR, POM/acrylate, POM/MBS, PPO/HIPS, PPO/PA 6.6 and copolymers, PA/HDPE, PA/PP, PA/PPO, PBT/PC/ABS or PBT/PET/PC.
   Other polymers may additionally contain in the form as admixtures or as copolymers a wide variety of synthetic polymers including polyolefins, polystyrenes, polyesters, polyethers, polyamides, poly(meth)acrylates, thermoplastic polyurethanes, polysulphones, polyacetals and PVC, including suitable compatibilizing agents. For example, the component (b) may additionally contain thermoplastic polymers selected from the group of resins consisting of polyolefins, thermoplastic polyurethanes, styrene polymers and copolymers thereof. Specific embodiments include polypropylene (PP), polyethylene (PE), polyamide (PA), polybutylene terephthalate (PBT), polyethylene terephthalate (PET), glycol-modified polycyclohexylenemethylene terephthalate (PCTG), polysulphone (PSU), polymethylmethacrylate (PMMA), thermoplastic polyurethane (TPU), acrylonitrile-butadiene-styrene (ABS), acrylonitrile-styrene-acrylic ester (ASA), acrylonitrile-ethylene-propylene-styrene (AES), styrene-maleic anhydride (SMA) or high impact polystyrene (HIPS).

According to a preferred embodiment, the thermoplastic polymer is selected from the group consisted of polyamides and co-polyamides, polyolefins (such as polypropylene), polyester and polyurethanes.

According to the present invention, the average particle size (D₅₀) of the thermoplastic polymer can be in the range from 0.1 to 1000 μm, for example from 0.1 to 500 μm or from 0.1 to 300 μm, or from 0.1 to 200 μm.

The amount of the thermoplastic polymer can be in the range from 30 to 99.99 wt. %, for example 30 wt. %, 40 wt. %, 50 wt. %, 60 wt. %, 70 wt. %, 80 wt. %, 85 wt. %, 90 wt. %, 92 wt. %, 95 wt. %, 96 wt. %, 97 wt. %, 98 wt. %, 99 wt. %, 99.1 wt. %, 99.3 wt. %, 99.5 wt. %, 99.7 wt. %, 99.9 wt. %, 99.91 wt. %, 99.92 wt. %, 99.93 wt. %, 99.94 wt. %, 99.95 wt. %, 99.96 wt. %, 99.97 wt. %, or 99.98 wt. %, for example from 30 to 99.96 wt. % or from 30 to 99.92 wt. %, preferably from 50 to 99.96 wt. % or from 50 to 99.92 wt. %, or from 60 to 99.96 wt. %, more preferably from 70 to 99.92 wt. % 15 or from 80 to 99.92 wt. % or from 90 to 99.92 wt. % or from 70 to 99.9 wt. % or from 80 to 99.9 wt. % or from 90 to 99.9 wt. %, based on the total weight of the thermoplastic pulverulent composition.

The thermoplastic pulverulent composition can optionally comprises at least one auxiliary as component (c). As auxiliaries, mention may be made by way of preferred example of surface-active substances, nucleating agents, lubricant wax, dyes, pigments, catalyst, UV absorbers and stabilizers, e.g. against oxidation, hydrolysis, light, heat or discoloration, inorganic and/or organic fillers and reinforcing materials. As hydrolysis inhibitors, preference is given to oligomeric and/or polymeric aliphatic or aromatic carbodiimides. To stabilize 3D-printed objects of the invention against aging and damaging environmental influences, stabilizers are added to system in preferred embodiments. Examples of the inorganic and/or organic fillers and reinforcing materials can include glass bead, glass fiber and carbon fiber.

If the composition of the invention is exposed to thermo-oxidative damage during use, in preferred embodiments antioxidants are added. Preference is given to phenolic antioxidants. Phenolic antioxidants such as Irganox® 1010 from BASF SE are given in Plastics Additive Handbook, 5th edition, H. Zweifel, ed., Hanser Publishers, Munich, 2001, pages 98-107, page 116 and page 121.

If the composition of the invention is exposed to UV light, it is preferably additionally stabilized with a UV absorber. UV absorbers are generally known as molecules which absorb high-energy UV light and dissipate energy. Customary UV absorbers which are employed in industry belong, for example, to the group of cinnamic esters, diphenylcyan acrylates, formamidines, benzylidenemalonates, diarylbutadienes, triazines and benzotriazoles. Examples of commercial UV absorbers may be found in Plastics Additive Handbook, 5th edition, H. Zweifel, ed, Hanser Publishers, Munich, 2001, pages 116-122.

Further details regarding the abovementioned auxiliaries may be found in the specialist literature, e.g. in Plastics Additive Handbook, 5th edition, H. Zweifel, ed, Hanser Publishers, Munich, 2001.

The amount of at least one auxiliary can be in the range from 0 to 69 wt. %, 0 to 59 wt. %, preferably from 0 to 49 wt. %, 0 to 39 wt. % or from 0 to 29 wt. % or from 0 to 19 wt. %, based on the total weight of the thermoplastic pulverulent composition.

In an embodiment, the thermoplastic pulverulent composition of the present invention comprising
(a) 0.01 to 10 wt. % of at least one silica particle treated with alkoxysilane;
(b) 30 to 99.99 wt. % of at least one thermoplastic polymer; and
(c) 0 to 69 wt. % of at least one auxiliary,
in each case based on the total weight of the thermoplastic pulverulent composition.

In an embodiment, the thermoplastic pulverulent composition of the present invention comprising
(a) 0.01 to 8 wt. % of at least one silica particle treated with alkoxysilane;
(b) 30 to 99.99 wt. % of at least one thermoplastic polymer; and
(c) 0 to 69 wt. % of at least one auxiliary,
in each case based on the total weight of the thermoplastic pulverulent composition.

In an embodiment, the thermoplastic pulverulent composition of the present invention comprising
(a) 0.04 to 8 wt. % of at least one silica particle treated with alkoxysilane;
(b) 30 to 99.96 wt. % of at least one thermoplastic polymer; and
(c) 0 to 69 wt. % of at least one auxiliary,
in each case based on the total weight of the thermoplastic pulverulent composition.

In an embodiment, the thermoplastic pulverulent composition of the present invention comprising
(a) 0.01 to 5 wt. % of at least one silica particle treated with alkoxysilane;
(b) 30 to 99.99 wt. % of at least one thermoplastic polymer; and
(c) 0 to 69 wt. % of at least one auxiliary,
in each case based on the total weight of the thermoplastic pulverulent composition.

In an embodiment, the thermoplastic pulverulent composition of the present invention comprising
(a) 0.01 to 5 wt. % of at least one silica particle treated with alkoxysilane;
(b) 50 to 99.96 wt. % of at least one thermoplastic polymer; and
(c) 0 to 49 wt. % of at least one auxiliary,
in each case based on the total weight of the thermoplastic pulverulent composition.

In an embodiment, the thermoplastic pulverulent composition of the present invention comprising
(a) 0.01 to 5 wt. % of at least one silica particle treated with alkoxysilane;
(b) 70 to 99.92 wt. % of at least one thermoplastic polymer; and
(c) 0 to 29 wt. % of at least one auxiliary,
in each case based on the total weight of the thermoplastic pulverulent composition.

In an embodiment, the thermoplastic pulverulent composition of the present invention comprising
(a) 0.04 to 3 wt. % of at least one silica particle treated with alkoxysilane;
(b) 30 to 99.96 wt. % of at least one thermoplastic polymer; and
(c) 0 to 69 wt. % of at least one auxiliary,
in each case based on the total weight of the thermoplastic pulverulent composition.

In an embodiment, the thermoplastic pulverulent composition of the present invention comprising
(a) 0.04 to 3 wt. % of at least one silica particle treated with alkoxysilane;
(b) 50 to 99.96 wt. % of at least one thermoplastic polymer; and
(c) 0 to 49 wt. % of at least one auxiliary,
in each case based on the total weight of the thermoplastic pulverulent composition.

In an embodiment, the thermoplastic pulverulent composition of the present invention comprising
(a) 0.04 to 3 wt. % of at least one silica particle treated with alkoxysilane;
(b) 70 to 99.92 wt. % of at least one thermoplastic polymer; and
(c) 0 to 29 wt. % of at least one auxiliary,
in each case based on the total weight of the thermoplastic pulverulent composition.

In an embodiment, the thermoplastic pulverulent composition of the present invention comprising
(a) 0.08 to 2 wt. % of at least one silica particle treated with alkoxysilane;
(b) 30 to 99.92 wt. % of at least one thermoplastic polymer; and
(c) 0 to 69 wt. % of at least one auxiliary,
in each case based on the total weight of the thermoplastic pulverulent composition.

In an embodiment, the thermoplastic pulverulent composition of the present invention comprising
(a) 0.08 to 2 wt. % of at least one silica particle treated with alkoxysilane;
(b) 50 to 99.92 wt. % of at least one thermoplastic polymer; and
(c) 0 to 49 wt. % of at least one auxiliary,
in each case based on the total weight of the thermoplastic pulverulent composition.

In an embodiment, the thermoplastic pulverulent composition of the present invention comprising
(a) 0.08 to 2 wt. % of at least one silica particle treated with alkoxysilane;
(b) 70 to 99.92 wt. % of at least one thermoplastic polymer; and
(c) 0 to 29 wt. % of at least one auxiliary,
in each case based on the total weight of the thermoplastic pulverulent composition.

In an embodiment, the thermoplastic pulverulent composition of the present invention comprising
(a) 0.1 to 2 wt. % of at least one silica particle treated with alkoxysilane;
(b) 70 to 99.9 wt. % of at least one thermoplastic polymer; and
(c) 0 to 29 wt. % of at least one auxiliary,
in each case based on the total weight of the thermoplastic pulverulent composition.

In an embodiment, the thermoplastic pulverulent composition of the present invention comprising
(a) 0.1 to 2 wt. % of at least one silica particle treated with alkoxysilane;
(b) 80 to 99.9 wt. % of at least one thermoplastic polymer; and
(c) 0 to 19 wt. % of at least one auxiliary,
in each case based on the total weight of the thermoplastic pulverulent composition.

One aspect of the present disclosure relates to a process for preparing the thermoplastic pulverulent composition, which comprises:
(1) providing the powders of the above components (a), (b) and optional (c), and
(2) dry blending the powders under stirring.

According to an embodiment of the invention, the blending is carried out at room temperature with stirring. There is no particular restriction on the time of blending and rate of stirring, as long as the all components are uniformly mixed together. In a specific embodiment, the mixing is performed by means of a mixer at 800 to 3000 RPM, preferably 1000 to 2000 RPM for 30 seconds to 15 min, more preferably from 45 seconds to 5 min.

In a further aspect, the invention relates to a 3D-printed object formed from the thermoplastic pulverulent composition of the present invention.

According to an embodiment of the invention, the example of 3D-printed objects includes for example, sole, outerwear, cloth, footwear, toy, mat, tire, hose, gloves, seals.

In a further aspect, the invention relates to a process of forming 3D-printed object, comprising using the above thermoplastic pulverulent composition as the raw material for 3D-printing.

In an embodiment, the process comprises:
a) adding the thermoplastic pulverulent composition according to the present invention to a molding mixture, and
b) producing the molding by selectively bonding the powder.

In a preferred embodiment, the molding produced in step b) is produced by a process for the layer-by-layer build-up of three-dimensional objects by selectively bonding portions of a powder to on another.

According to the present invention, the selectively bonding comprises selective laser sintering, selective inhibition of the bonding of powders, 3D printing, or a microwave process.

### EXAMPLES

### Materials

### Thermoplastic Powder:

PA11: Adsint PA 11 Nat. from BASF 3D Printing Solutions GmbH, the average particle size (D₅₀) is 49 μm;
PA6: Ultrasint PA 6 X028 from BASF, the average particle size (D₅₀) is 70 μm.
   Silica Particle Treated with Alkoxysilane
TPX-5020 from Cabot, colloidal silica surface-treated with alkoxysilane, the average primary particle size is 65 nm; the BET surface area is 50 m²/g;
TPX-5075 from Cabot, colloidal silica surface-treated with alkoxysilane, the average primary particle size is 115 nm; the BET surface area is 30 m²/g.
TPX-5110 from Cabot, colloidal silica surface-treated with methacryl silane, the average primary particle size is 115 nm; the BET surface area is 30 m²/g;
TPX-5030 from Cabot, colloidal silica surface-treated with HMDZ (hexamethyldisilazane), the average primary particle size is 115 nm; the BET surface area is 30 m²/g.

### Methods

All samples were printed by Farsoon HT251 SLS 3D printer.
Tensile strength, Young's modulus and elongation at break were measured at a rate of 6 mm/min (according to ISO527-21/A15 2012) by Zwick Z050.
Dynamic density, avalanche angle and Rest angle were determined by means of a Revolution Powder Analyzer (RPA); Analysis parameters: Rotation rate: 0.6 rpm, imaging rate: 15 FPS, Prep time: 30 s, Avalanche threshold: 0.65%, stop test after: avalanches 128.
Unnotched Impact strength: Izod ISO-180.95/2001.
Surface roughness: ISO 16610-21 0.8 mm.

### Examples 1a, 1b, 2, 2a, 3 and 4—Preparing the Thermoplastic Pulverulent Composition

The thermoplastic pulverulent compositions in examples 1a, 1b, 2, 2a, 3 and 4 were prepared by blending the powders of the components as shown in table 1. The blending experiments were carried out on the HTS-5 High speed mixer from Dongguan Huanxin Machinery Co., Ltd. Each component was weighted according to the amounts as shown in table 1. The powders were mixed under 1400 rpm for 60 seconds to obtain the thermoplastic pulverulent composition.

TABLE 1
the amount of each component

| Example | 1a | 1b | 2 | 2a | 3 | 4 |
|---|---|---|---|---|---|---|
| PA 6 (g) | 10000 | 10000 | | | 10000 | 10000 |
| PA 11 (g) | | | 10000 | 10000 | | |
| TPX-5020 (g) | 20 | | | | | |
| TPX-5075 (g) | | 20 | | 50 | | |
| TPX-5110 (g) | | | | | 20 | |
| TPX5030 (g) | | | | | | 20 |

The thermoplastic pulverulent compositions in examples 1a, 1b and 2a comprise silica particle treated with alkoxysilane and thus are examples according to the present invention. Examples 2, 3 and 4 are comparative examples. The thermoplastic pulverulent composition of example 2 does not contain silica particle. TPX-5110 used in example 3 is a silica surface-treated with methacryl silane. TPX5030 used in example 4 is a silica surface-treated with HMDZ.

### Example 5—3D Printing

The thermoplastic pulverulent compositions prepared in examples 1a, 1b, 2, 2a, 3 and 4 were printed by HT251 Selective Laser Sintering 3D printer which was manufactured from Farsoon. For a typical printing process, thermoplastic pulverulent composition were loaded in the feed chamber of the printer. For all printing processes, the printing parameters need to be adjusted according to different type of thermoplastic pulverulent compositions and their cracking or warping phenomenon during printing process. Detailed printing parameters for each thermoplastic pulverulent composition were listed in the table 2.

Post-treatment process: Once the printing process was completed and the printed objects were cooled, the build chamber was removed from the printer and transferred to a cleaning station, the printed objects were separated from the excess powders to obtain the final 3D-printed objects.

TABLE 2
Printing parameters for the compositions
from examples 1a, 1b, 2, 2a, 3 and 4

| Example | 1a | 1b | 2 | 2a | 3 | 4 |
|---|---|---|---|---|---|---|
| Part bed T | 204.5 | 204.5 | 183.0 | 183.0 | 204.5 | 204.5 |
| (° C.) | | | | | | |
| Feed T (° C.) | 150 | 150 | 150 | 145 | 150 | 150 |
| Piston T (° C.) | 195 | 195 | 165 | 165 | 195 | 195 |
| Cylinder T | 185 | 185 | 155 | 155 | 185 | 185 |
| (° C.) | | | | | | |
| Laser power | 35 | 35 | 35 | 35 | 35 | 35 |
| (W) | | | | | | |
| Outline laser | 7 | 7 | 7 | 7 | 7 | 7 |
| power (W) | | | | | | |
| Laser scan | 0.2 | 0.2 | 0.2 | 0.2 | 0.2 | 0.2 |
| spacing (mm) | | | | | | |
| Scan count | 1 | 1 | 1 | 1 | 1 | 1 |
| Roller speed | 180 | 180 | 180 | 180 | 180 | 180 |
| (mm/s) | | | | | | |
| Laser scan | 7.62 | 7.62 | 7.62 | 7.62 | 7.62 | 7.62 |
| speed (m/s) | | | | | | |
| Layer thickness | 0.1 | 0.1 | 0.1 | 0.1 | 0.1 | 0.1 |
| (mm) | | | | | | |

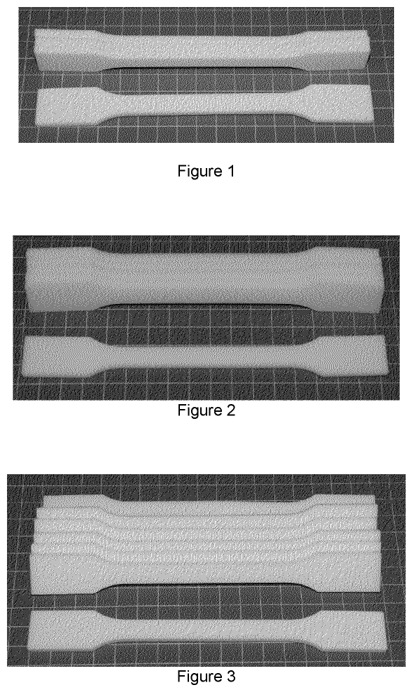

Pictures of printed samples prepared from the thermoplastic pulverulent compositions of example 1a, example 1b and example 2a were shown in FIG. 1, FIG. 2 and FIG. 3, respectively. As can be seen, the thermoplastic pulverulent compositions of example 1a, example 1b and example 2a could be successfully used to form 3D-printed objects.

Avalanche angle, rest angle, dynamic density of the thermoplastic pulverulent compositions, Ra and Rz, unnotched impact strength and the mechanical properties of all printed samples were tested, and the results were summarized in table 3.

TABLE 3

| Example | 1a | 1b | 2 | 2a | 3 | 4 |
|---|---|---|---|---|---|---|
| Avalanche angle (°) | 51.3 | 56.6 | 46.5 | 51.2 | 55.3 | 54.5 |
| Rest Angle (°) | 38.5 | 41.5 | 35.3 | 41.3 | 39.7 | 39.1 |
| Dynamic Density (g/cm³) | 0.56 | 0.54 | 0.50 | 0.53 | 0.55 | 0.56 |
| Young's Modulus (MPa) | 3190 | 3262 | 1832 | 1570 | 3418 | 3338 |
| Tensile Strength (MPa) | 72.0 | 75.0 | 52.1 | 46.9 | 69.0 | 71.5 |
| Elongation at break (%) | 7.6 | 8.6 | 22.3 | 35.8 | 2.8 | 3.0 |
| Unnotched impact strength | 12.3 | 22.0 | >135 | >135 | / | / |
| (MPa) | | | | | | |
| Ra (μm) | 2.5 | 10.0 | 8.3 | 5.2 | / | / |
| Rz (μm) | 15.3 | 51.1 | 48.6 | 30.7 | / | / |

“/”: not measured

All thermoplastic pulverulent compositions of examples 1a, 1b and 2a exhibited good powder flowability (as shown by Avalanche angle and Rest angle) for 3D printing process. The printed samples based on examples 1a and 1b also exhibited excellent impact strength. A silica surface-treated with methacryl silane and a silica surface-treated with HMDZ are used in examples 3 and 4, respectively, the printed samples based on examples 3 and 4 show much lower elongation at break comparing with those of examples 1a and 1b.

Comparing with example 2, the addition of silica treated with alkoxysilane in the thermoplastic pulverulent composition of example 2a can improve elongation at break of PA11 from 22.3% to 35.8%. The surface roughness (as shown by Ra and Rz) of PA11 printed sample based on example 2a are also improved.

1.-15. (canceled)

16. A thermoplastic pulverulent composition comprising:
(a) at least one silica particle treated with alkoxysilane; and
(b) at least one thermoplastic polymer.

17. The thermoplastic pulverulent composition according to claim 16, wherein the silica particle treated with alkoxysilane has a BET surface area of from 15 to 600 m²/g.

18. The thermoplastic pulverulent composition according to claim 17, wherein the average primary particle size of the silica particle treated with alkoxysilane is in the range of from 5 to 500 nm.

19. The thermoplastic pulverulent composition according to claim 16, wherein the amount of silica particle treated with alkoxysilane is in the range of from 0.01 to 10 wt. %, based on the total weight of the thermoplastic pulverulent composition.

20. The thermoplastic pulverulent composition according to claim 16, wherein the thermoplastic polymer is selected from the group consisted of polyolefins, hydrocarbon resins, aromatic homopolymers and copolymers derived from vinyl aromatic monomers, halogen-containing polymers, polymers derived from α,β-unsaturated acids and derivatives thereof, polymers derived from unsaturated alcohols and amines or the acyl derivatives or acetals thereof, homopolymers and copolymers of cyclic ethers, polyacetals, polyphenylene oxides and sulphides, polyamides and co-polyamides, polyureas, polyimides, polyamide imides, polyether imides, polyester imides, polyhydantoins, polybenzimidazoles, polyesters, polyketones, polysulphones, polyether sulphones, polyether ketones, polycarbonates, polyurethanes and blends of the aforementioned polymers.

21. The thermoplastic pulverulent composition according to claim 16, wherein the thermoplastic polymer is selected from the group consisted of polyamides and co-polyamides, polyolefins, polyester and polyurethanes, and blends of the aforementioned polymers.

22. The thermoplastic pulverulent composition according to claim 16, wherein the average particle size (D₅₀) of the thermoplastic polymer is in the range from 0.1 to 1000 μm.

23. The thermoplastic pulverulent composition according to claim 16, wherein the amount of the thermoplastic polymer is in the range of from 30 to 99.99 wt. %, based on the total weight of the thermoplastic pulverulent composition.

24. The thermoplastic pulverulent composition according to claim 16, wherein the thermoplastic pulverulent composition comprises at least one auxiliary in an amount of from 0 to 69 wt. %, based on the total weight of the thermoplastic pulverulent composition.

25. A 3D-printed object formed from the thermoplastic pulverulent composition according to claim 16.

26. The 3D-printed object according to claim 25, wherein the 3D-printed objects include sole, outerwear, cloth, footwear, toy, mat, tire, hose, gloves, and seals.

27. A process of forming 3D-printed object, comprising using the thermoplastic pulverulent composition according to claim 16.

28. The process according to claim 27, wherein the process comprises: adding a thermoplastic pulverulent composition comprising at least one silica particle treated with alkoxysilane; and at least one thermoplastic polymer,
a) to a molding mixture, and
b) producing the molding by selectively bonding the powder.

29. The process according to claim 27, wherein the molding produced in step b) is produced by a process for the layer-by-layer build-up of three-dimensional objects by selectively bonding portions of a powder to on another.

30. The process according to claim 28, wherein the selectively bonding comprises selective laser sintering, selective inhibition of the bonding of powders, 3D printing, or a microwave process.
